(19) United States
(12) Patent Application Publication
(10) Pub. No.: US 2010/0137374 A1
(43) Pub. Date: Jun. 3, 2010

(54) SOLID FORMULATIONS OF CARBOXAMIDE ARTHROPODICIDES

(75) Inventors: Isaac Billy Annan, Newark, DE (US); John Henry Green, Oxford (GB); Oliver Walter Gutsche, Wilmington, DE (US); Hector Eduardo Portillo, Newark, DE (US)

Correspondence Address: E I DU PONT DE NEMOURS AND COMPANY;LEGAL PATENT RECORDS CENTER, BARLEY MILL PLAZA 25/1122B, 4417 LANCASTER PIKE, WILMINGTON, DE, 19805, US

(73) Assignee: E.I. Dupont de Nemours and Company, Wimington, DE (US)

(21) Appl. No.: 12/596,673

(22) PCT Filed: Jun. 20, 2008
(86) PCT No.: PCT/US08/67588

§ 371 Date: Oct. 20, 2009

Related U.S. Application Data
(60) Provisional application No. 60/937,346, filed on Jun. 27, 2007.

(51) Int. Cl. A01N 43/40; A01N 37/18; A01P 7/00

(52) U.S. Cl. 514/341; 514/613; 514/616

(57) ABSTRACT

Disclosed is a solid arthropodicide composition comprising by weight
(a) from 0.1 to 50% of one or more carboxamide arthropodicides;
(b) from 0.5 to 95% of a particulate component comprising particles of a solid carrier infiltrated with a water-immiscible liquid constituent;
(c) from 0.1 to 50% of a surfactant component having dispersing and wetting properties; and
(d) from 0 to 99.3% of one or more additional formulating ingredients.

### FIELD OF THE INVENTION

This invention relates to certain solid formulations of carboxamide arthropodicides.

### BACKGROUND OF THE INVENTION

The control of arthropod pests is extremely important in achieving high crop efficiency. Damage by arthropod pests to growing and stored agronomic crops can cause significant reduction in productivity and thereby result in increased costs to the consumer. The control of arthropod pests in forestry, greenhouse crops, ornamentals, nursery crops, stored food and fiber products, livestock, household, turf, wood products, and public and animal health is also important.

Anthranilamides (see U.S. Pat. No. 6,747,947, PCT Publications WO 2003/015519 and WO 2004/067528) and phthalic diamides (see U.S. Pat. No. 6,603,044) are recently discovered classes of carboxamide arthropodicides having activity against numerous arthropod pests of economic importance.

Typically chemical active ingredients for protecting plants, e.g., arthropodicides, are formulated as compositions (formulations) comprising the active compound(s) and inert ingredients such as carriers and adjuvants. These compositions can be applied by the user to the target pests or plants to be protected either in undiluted form or after dilution with water. Formulated compositions of plant protection products can be generally categorized as solid or liquid formulations. Liquid compositions include solutions (including emulsifiable concentrates), suspensions and emulsions (including microemulsions and/or suspoemulsions). Solid compositions include dusts, powders, granules, pellets, prills, pastilles and tablets. Each formulation type has advantages and disadvantages relative to other formulation types, and the optimal type for each application will depend upon the physical and biological characteristics of the active ingredient, and the conditions of storage and use, including pests to be controlled, plant parts or other locus to be protected, environmental conditions, etc.

Certain inert formulating ingredients, commonly known as adjuvants, can promote or prolong the efficacy of active ingredients. For example, water-immiscible liquids such as petroleum distillates, vegetable oils and derivatives such as methylated vegetable oils can improve adhesion of active ingredients to the waxy cuticle of leaves, thereby increasing improving wash-off resistance. Moreover, by improving adhesion and contact, such water-immiscible liquids can facilitate uptake of active ingredients into the cuticle, from which they can be further transported through the vascular system (e.g., phloem) of the plant. The penetration and translaminar movement of arthropodicide active ingredients through the leaf cuticle and epidermal cells, and their subsequent distribution in the mesophyll cells, vascular system and other tissues is particularly desirable for controlling arthropod pests that primarily obtain nourishment by extracting plant sap from the internal structures of plant parts such as leaves. Particularly noteworthy examples of such arthropod pests are piercing-sucking pests of the order Homoptera, such as members of the family Aleyrodidae (whiteflies), the family Aphidadae (aphids), the family Delphacidae (planthoppers) and the family Cicadellidae (leafhoppers).

Although water-immiscible liquid adjuvants are mostly used as additives introduced into spray tanks separately from formulated compositions of active ingredients, they would be more conveniently included in the formulated compositions of active ingredients. Furthermore, some countries require registration of liquid adjuvants added separately to spray tanks, and other countries may restrict or prohibit forming such spray tank mixtures. Because of their physical nature, liquid formulation compositions can readily include liquid ingredients, but even for liquid compositions a challenge is to include enough water-immiscible liquid in the composition so that the adjuvant effect of the water-immiscible liquid on the active ingredient is not lost on dilution of the formulated composition in the spray tank. The challenge is even more difficult for solid compositions, which inherently cannot readily incorporate substantial quantities of liquid ingredients and still remain solid. Nevertheless, solid formulated compositions comprising a carboxamide arthropodicide active ingredient together with an amount of water-immiscible liquid sufficient to enhance the efficacy of the active ingredient have now been discovered.

### SUMMARY OF THE INVENTION

This invention is directed to a solid arthropodicide composition comprising by weight
(a) from 0.1 to 50% of one or more carboxamide arthropodicides;
(b) from 0.5 to 95% of a particulate component comprising particles of a solid carrier infiltrated with a water-immiscible liquid constituent;
(c) from 0.1 to 50% of a surfactant component having dispersing and wetting properties; and
(d) from 0 to 99.3% of one or more additional formulating ingredients.

### DETAILED DESCRIPTION OF THE INVENTION

As used herein, the terms “comprises,” “comprising,” “includes,” “including,” “has,” “having” or any other variation thereof, are intended to cover a non-exclusive inclusion. For example, a composition, process, method, article, or apparatus that comprises a list of elements is not necessarily limited to only those elements but may include other elements not expressly listed or inherent to such composition, process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Also, the indefinite articles “a” and “an” preceding an element or component of the invention are intended to be nonrestrictive regarding the number of instances (i.e. occurrences) of the element or component. Therefore “a” or “an” should be read to include one or at least one, and the singular word form of the element or component also includes the plural unless the number is obviously meant to be singular.

As used herein, the term “silica” refers to a solid chemical substance consisting mostly (e.g., at least 90 or 95% by weight) of silicon and oxygen atoms in a ratio of about two oxygen atoms to one silicon atom, thus having the empirical formula of SiO₂. Silicas include, for example, precipitated silicas, fumed silicas, amorphous silicas, diatomaceous silicas (also known as diatomaceous earths) as well as silanized forms of these silicas. The term “silicate” refers to a solid chemical substance consisting mostly (e.g., at least 90 or 95% by weight) of atoms of silicon, oxygen and at least one metal (e.g., lithium, sodium, potassium, magnesium, calcium, aluminum).

As commonly known in the art, the term “saccharides” refers to chemical compounds that are either simple sugars (aldose or ketose monosaccharides) (e.g., glucose) or compounds in which simple sugars are connected together through glycosidic linkages to form disaccharides (e.g., sucrose, lactose), trisaccharides or polysaccharides. Polysaccharides include starches. Saccharides do not include compounds in which the substituents on the sugar molecule have been modified. For example, mannitol is not a sugar or saccharide, but can be regarded as a modified sugar or sugar derivative.

The term “pore” refers to a cavity in a particle (or particle agglomerate), the cavity having dimensions such that it is deeper than it is wide. Pores relevant to such measurements as pore diameter do not include closed pores (i.e. pores inaccessible to an external fluid and totally isolated from their neighbors). Accordingly, unless otherwise indicated in the present disclosure and claims, the term “pore” refers to an open pore (i.e. a pore accessible to a fluid external to the particulate component.) Pores allow infiltration (i.e. absorption) of a fluid into the interior of the particle. Intrusion volume is the volume of fluid that can be so accommodated per unit mass of the porous particulate. The unit used herein for intrusion volume is cm³/g. Internal surface area is the aggregate surface area of the pores or cavities per unit mass of the porous particulate. The unit used herein for internal surface area is m²/g. Mean pore diameter relates to the average diameter of the pores and is specified herein using the unit of μm (i.e. micron). As is well known in the art, intrusion volume, internal surface area and mean pore diameter of a porous substance can be measured using a mercury intrusion porosimeter, such as the model marketed by Porous Materials, Inc. (Ithaca, N.Y., USA). The values stated herein for intrusion volume, internal surface area and mean pore diameter refer to the values measured using a mercury intrusion porosimeter. For porosity measurements using a mercury intrusion porosimeter, cylindrical pores are assumed so that the mean pore diameter multiplied by the internal surface area equals the intrusion volume multiplied by 4.

Embodiments of the present invention include:
Embodiment 1. The composition described in the Summary of the Invention wherein component (a) (i.e. the one or more carboxamide arthropodicides) comprises a carboxamide arthropodicide comprising (at least) two vicinal carboxamide moieties bonded to carbon atoms.
Embodiment 1A. The composition described in the Summary of the Invention or Embodiment 1 wherein component (a) is selected from carboxamide arthropodicides that are ryanodine receptor ligands.
Embodiment 2. The composition described in the Summary of the Invention or Embodiment 1 or 1A wherein component (a) (i.e. the one or more carboxamide arthropodicides) is selected from anthranilamides of Formula 1, N-oxides, and salts thereof,

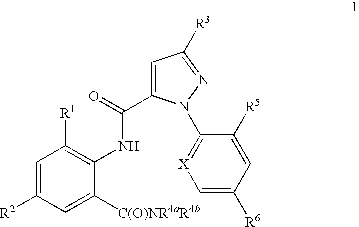

wherein
X is N, CF, CCl, CBr or CI;
R¹ is CH₃, Cl, Br or F;
R² is H, F, Cl, Br or —CN;
R³ is F, Cl, Br, C₁-C₄ haloalkyl or C₁-C₄ haloalkoxy;
R^{4a} is H, C₁-C₄ alkyl, cyclopropylmethyl or 1-cyclopropylethyl;
R^{4b} is H or CH₃;
R⁵ is H, F, Cl or Br; and
R⁶ is H, F, Cl or Br.
Embodiment 2A. The composition of Embodiment 2 wherein component (a) is selected from anthranilamides of Formula 1, N-oxides, and salts thereof, wherein X is N; R¹ is CH₃; R² is Cl or —CN; R³ is Cl, Br or CF₃; R^{4a} is C₁-C₄ alkyl; R^{4b} is H; R⁵ is Cl; and R⁶ is H.
Embodiment 2B. The composition of Embodiment 2A wherein component (a) is selected from anthranilamides of Formula 1, N-oxides, and salts thereof, wherein X is N; R¹ is CH₃; R² is Cl or —CN; R³ is Cl, Br or CF₃; R^{4a} is Me or CH(CH₃)₂; R^{4b} is H; R⁵ is Cl; and R⁶ is H.
Embodiment 2C. The composition of Embodiment 2B wherein component (a) is selected from the group consisting of:
N-[4-chloro-2-methyl-6-[[(1-methylethyl)amino]carbonyl]phenyl]-1-(3-chloro-2-pyridinyl)-3-(trifluoromethyl)-1H-pyrazole-5-carboxamide,
N-[4-chloro-2-methyl-6-[(methylamino)carbonyl]phenyl]-1-(3-chloro-2-pyridinyl)-3-(trifluoromethyl)-1H-pyrazole-5-carboxamide,
3-bromo-N-[4-chloro-2-methyl-6-[[(1-methylethyl)amino]carbonyl]phenyl]-1-(3-chloro-2-pyridinyl)-1H-pyrazole-5-carboxamide,
3-bromo-N-[4-chloro-2-methyl-6-[(methylamino)carbonyl]phenyl]-1-(3-chloro-2-pyridinyl)-1H-pyrazole-5-carboxamide,
3-bromo-1-(3-chloro-2-pyridinyl)-N-[4-cyano-2-methyl-6-[(methylamino)-carbonyl]phenyl]-1H-pyrazole-5-carboxamide,
1-(3-chloro-2-pyridinyl)-N-[4-cyano-2-methyl-6-[(methylamino)carbonyl]-phenyl]-3-(trifluoromethyl)-1H-pyrazole-5-carboxamide,
3-bromo-1-(2-chlorophenyl)-N-[4-cyano-2-methyl-6-[[(1-methylethyl)-amino]carbonyl]phenyl]-1H-pyrazole-5-carboxamide,
3-bromo-1-(2-chlorophenyl)-N-[4-cyano-2-methyl-6-[(methylamino)-carbonyl]phenyl]-1H-pyrazole-5-carboxamide,
3-bromo-1-(2-chlorophenyl)-N-[2,4-dichloro-6-[(methylamino)carbonyl]-phenyl]-1H-pyrazole-5-carboxamide,
3-bromo-N-[4-chloro-2-[[(cyclopropylmethyl)amino]carbonyl]-6-methyl-phenyl]-1-(3-chloro-2-pyridinyl)-1H-pyrazole-5-carboxamide,
3-bromo-1-(3-chloro-2-pyridinyl)-N-[4-cyano-2-[[(cyclopropylmethyl)-amino]-carbonyl]-6-methylphenyl]-1H-pyrazole-5-carboxamide,
3-bromo-N-[4-chloro-2-[[(1-cyclopropylethyl)amino]carbonyl]-6-methyl-phenyl]-1-(3-chloro-2-pyridinyl)-1H-pyrazole-5-carboxamide, and
3-bromo-1-(3-chloro-2-pyridinyl)-N-[4-cyano-2-[[(1-cyclopropylethyl)-amino]carbonyl]-6-methylphenyl]-1H-pyrazole-5-carboxamide.
   Embodiment 2D. The composition of any one of Embodiments 2 through 2C wherein component (a) comprises 3-bromo-1-(3-chloro-2-pyridinyl)-N-[4-cyano-2-methyl-6-[(methylamino)carbonyl]phenyl]-1H-pyrazole-5-carboxamide.
   Embodiment 2E. The composition of any one of Embodiments 2 through 2C wherein component (a) comprises 3-bromo-N-[4-chloro-2-methyl-6-[(methylamino)carbonyl]phenyl]-1-(3-chloro-2-pyridinyl)-1H-pyrazole-5-carboxamide.
   Embodiment 3. The composition described in the Summary of the Invention or Embodiment 1 or 1A wherein component (a) (i.e. the one or more carboxamide arthropodicides) is selected from phthalic diamides of Formula 2 and salts thereof,

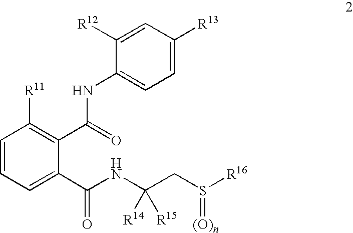

wherein
   R¹¹ is CH₃, Cl, Br or I;
   R¹² is CH₃ or Cl;
   R¹³ is C₁-C₃ fluoroalkyl;
   R¹⁴ is H or CH₃;
   R¹⁵ is H or CH₃;
   R¹⁶ is C₁-C₂ alkyl; and
   n is 0, 1 or 2.
Embodiment 3A. The composition of Embodiment 3 wherein component (a) is selected from phthalic diamides of Formula 2 and salts thereof, wherein R¹¹ is Cl, Br or I; R¹² is CH₃; R¹³ is CF₃, CF₂CF₃ or CF(CF₃)₂; and R¹⁶ is CH₃.
Embodiment 3B. The composition of Embodiment 3A wherein component (a) is N²-[1,1-dimethyl-2-(methylsulfonyl)ethyl]-3-iodo-N¹-[2-methyl-4-[1,2,2,2-tetra-fluoro-1-(trifluoromethyl)ethyl]phenyl]-1,2-benzenedicarboxamide.
Embodiment 3C. The composition of Embodiment 3 or 3A wherein component (a) comprises N²-[1,1-dimethyl-2-(methylsulfonyl)ethyl]-3-iodo-N¹-[2-methyl-4-[1,2,2,2-tetrafluoro-1-(trifluoromethyl)ethyl]phenyl]-1,2-benzenedicarboxamide.
Embodiment 4. The composition described in the Summary of the Invention or any one of Embodiments 1 through 3C wherein component (a) (i.e. the one or more carboxamide arthropodicides) has a melting point above about 80° C. (neat, in the absence of other constituents or components).
Embodiment 4A. The composition of Embodiment 4 wherein component (a) has a melting point above about 100° C.
Embodiment 4B. The composition of Embodiment 4A wherein component (a) has a melting point above about 120° C.
Embodiment 4C. The composition of Embodiment 4B wherein component (a) has a melting point above about 160° C.
Embodiment 4D. The composition of Embodiment 4C wherein component (a) has a melting point above about 180° C.
Embodiment 4E. The composition of Embodiment 4D wherein component (a) has a melting point above about 200° C.
Embodiment 5. The composition described in the Summary of the Invention or any one of Embodiments 1 through 4E wherein component (a) (i.e. the one or more carboxamide arthropodicides) is at least about 1% of the composition by weight.
Embodiment 6. The composition described in the Summary of the Invention or any one of Embodiments 1 through 5 wherein component (a) is no more than about 20% of the composition by weight.
Embodiment 6A. The composition of Embodiment 6 wherein component (a) is no more than about 10% of the composition by weight.
Embodiment 7. The composition described in the Summary of the Invention or any one of Embodiments 1 through 6A wherein the mean particle size (i.e. volume moment mean, De Brouker mean) of the particles of the solid carrier in component (b) (i.e. the particulate component comprising particles of a solid carrier infiltrated with a water-immiscible liquid constituent) is at least about 0.1 μm.
Embodiment 7A. The composition of Embodiment 7 wherein the mean particle size of the particles of the solid carrier in component (b) is at least about 5 μm.
Embodiment 8. The composition described in the Summary of the Invention or any one of Embodiments 1 through 7A wherein the mean particle size of the particles of the solid carrier in component (b) is no more than about 200 μm.
Embodiment 8A. The composition of Embodiment 8 wherein the mean particle size of particles of the solid carrier in component (b) is no more than about 20 μm.
Embodiment 9. The composition described in the Summary of the Invention or any one of Embodiments 1 through 8A wherein the solid carrier in component (b) has a mean pore diameter of at least about 0.05 μm.
Embodiment 9A. The composition of Embodiment 9 wherein the solid carrier in component (b) has a mean pore diameter of at least about 0.1 μm.
Embodiment 10. The composition described in the Summary of the Invention or any one of Embodiments 1 through 9A wherein the solid carrier in component (b) has a mean pore diameter of no more than about 2 μm.
Embodiment 10A. The composition of Embodiment 10 wherein the solid carrier in component (b) has a mean pore diameter of no more than about 1 μm.
Embodiment 10B. The composition of Embodiment 10A wherein the solid carrier in component (b) has a mean pore diameter of no more than about 0.5 μm.
Embodiment 11. The composition described in the Summary of the Invention or any one of Embodiments 1 through 10B wherein the solid carrier in component (b) has an internal surface area of at least about 1 m²/g.
Embodiment 11A. The composition of Embodiment 11 wherein the solid carrier in component (b) has an internal surface area of at least about 20 m²/g.
Embodiment 11B. The composition of Embodiment 11A wherein the solid carrier in component (b) has an internal surface area of at least about 80 m²/g.
Embodiment 11C. The composition of Embodiment 11B wherein the solid carrier in component (b) has an internal surface area of at least about 90 m²/g.
Embodiment 11D. The composition of Embodiment 11C wherein the solid carrier in component (b) has an internal surface area of at least about 100 m²/g.
Embodiment 12. The composition described in the Summary of the Invention or any one of Embodiments 1 through 11D wherein the solid carrier in component (b) has an internal surface area of no more than about 600 m²/g.
Embodiment 12A. The composition of Embodiment 12 wherein the solid carrier in component (b) has an internal surface area of no more than about 400 m²/g.
Embodiment 12B. The composition of Embodiment 12A wherein the solid carrier in component (b) has an internal surface area of no more than about 200 m²/g.
Embodiment 13. The composition described in the Summary of the Invention or any one of Embodiments 1 through 12B wherein the solid carrier in component (b) has an intrusion volume of at least about 1 cm³/g.
Embodiment 13A. The composition of Embodiment 13 wherein the solid carrier in component (b) has an intrusion volume of at least about 2 cm³/g.
Embodiment 13B. The composition of Embodiment 13A wherein the solid carrier in component (b) has an intrusion volume of at least about 3 cm³/g.
Embodiment 13C. The composition of Embodiment 13B wherein the solid carrier in component (b) has an intrusion volume of at least about 4 cm³/g.
Embodiment 13D. The composition of Embodiment 13C wherein the solid carrier in component (b) has an intrusion volume of at least about 5 cm³/g.
Embodiment 14. The composition described in the Summary of the Invention or any one of Embodiments 1 through 13D wherein the solid carrier in component (b) has an intrusion volume of no more than about 20 cm³/g.
Embodiment 14A. The composition of Embodiment 14 wherein the solid carrier in component (b) has an intrusion volume of no more than about 10 cm³/g.
Embodiment 15. The composition described in the Summary of the Invention or any one of Embodiments 1 through 14A wherein the solid carrier in component (b) comprises at least one silica or silicate.
Embodiment 15A. The composition of Embodiment 15 wherein the solid carrier in component (b) comprises at least one silica or silicate selected from the group consisting of silicas and silicates of lithium, sodium, potassium, magnesium, calcium and aluminum (including mixtures thereof).
Embodiment 15B. The composition of Embodiment 15A wherein the solid carrier in component (b) comprises at least one silica or silicate selected from the group consisting of silicas and silicates of magnesium, calcium and aluminum (including mixtures thereof).
Embodiment 15C. The composition of Embodiment 15B wherein the solid carrier in component (b) comprises calcium silicate.
Embodiment 16. The composition described in the Summary of the Invention or any one of Embodiments 1 through 15C wherein the solid carrier has water solubility at 20° C. of not more than about 10 g/L.
Embodiment 16A. The composition of Embodiment 15 wherein the solid carrier has water solubility at 20° C. of not more than about 5 g/L.
Embodiment 16B. The composition of Embodiment 15A wherein the solid carrier has water solubility at 20° C. of not more than about 2 g/L.
Embodiment 16C. The composition of Embodiment 15B wherein the solid carrier has water solubility at 20° C. of not more than about 1 g/L.
Embodiment 17. The composition described in the Summary of the Invention or any one of Embodiments 1 through 16C wherein the water-immiscible liquid constituent of component (b) has a normal boiling point of at least about 200° C.
Embodiment 17A. The composition of Embodiment 17 wherein the water-immiscible liquid constituent has a normal boiling point of at least about 250° C.
Embodiment 17B. The composition of Embodiment 17A wherein the water-immiscible liquid constituent has a normal boiling point of at least about 280° C.
Embodiment 17C. The composition described in the Summary of the Invention or any one of Embodiments 1 through 17B wherein the water-immiscible liquid constituent comprises at least one substance selected from fatty acid esters of C₁-C₄ alkanols (including those derived from seed and fruit oils), seed and fruit oils and mineral oils.
Embodiment 17D. The composition of Embodiment 17 wherein the water-immiscible liquid constituent comprises a fatty acid ester of a C₁-C₄ alkanol.
Embodiment 17E. The composition of Embodiment 17D wherein the water-immiscible liquid constituent comprises a fatty acid ester of a C₁-C₄ alkanol.
Embodiment 17F. The composition of Embodiment 17E wherein the water-immiscible liquid constituent comprises a C₁₀-C₂₂ fatty acid ester of a C₁-C₄ alkanol.
Embodiment 17G. The composition of Embodiment 17F wherein the water-immiscible liquid constituent comprises a C₁₂-C₂₀ fatty acid ester of a C₁-C₄ alkanol.
Embodiment 17H. The composition of Embodiment 17G wherein the water-immiscible liquid constituent comprises a C₁₆-C₁₈ fatty acid ester of a C₁-C₄ alkanol.
Embodiment 17I. The composition of Embodiment 17H wherein the water-immiscible liquid constituent comprises a C₁₆-C₁₈ fatty acid ester of a C₁-C₂ alkanol.
Embodiment 17J. The composition of Embodiment 17I wherein the water-immiscible liquid constituent comprises a C₁₆-C₁₈ fatty acid ester of methanol.
Embodiment 17K. The composition of Embodiment 17C wherein the water-immiscible liquid constituent comprises a methylated seed oil.
Embodiment 17L. The composition of Embodiment 17K wherein the water-immiscible liquid constituent comprises a methylated seed oil of oil palm, sunflower, soybean, cotton, rapeseed or linseed (including mixtures thereof).
Embodiment 17M. The composition of Embodiment 17L wherein the water-immiscible liquid constituent comprises a methylated seed oil of sunflower, soybean, cotton or linseed.
Embodiment 17N. The composition of Embodiment 17M wherein the water-immiscible liquid constituent comprises methylated soybean oil (methyl soyate).
Embodiment 17O. The composition of Embodiment 17N wherein the water-immiscible liquid constituent comprises a methylated seed oil of oil palm, sunflower, soybean, cotton or rapeseed.
Embodiment 17P. The composition of Embodiment 17O wherein the water-immiscible liquid constituent comprises a methylated seed oil of soybean or rapeseed.
Embodiment 18. The composition described in the Summary of the Invention or any one of Embodiments 1 through 17P wherein the weight ratio of the water-immiscible liquid constituent to the solid carrier in component (b) is at least about 1:3.
Embodiment 18A. The composition of Embodiment 18 wherein the weight ratio of the water-immiscible liquid constituent to the solid carrier in component (b) is at least about 1:2.
Embodiment 18B. The composition of Embodiment 18A wherein the weight ratio of the water-immiscible liquid constituent to the solid carrier in component (b) is at least about 2:3.
Embodiment 19. The composition described in the Summary of the Invention or any one of Embodiments 1 through 18B wherein the weight ratio of the water-immiscible liquid constituent to the solid carrier in component (b) is no more than about 5:1.
Embodiment 19A. The composition of Embodiment 19 wherein the weight ratio of the water-immiscible liquid constituent to the solid carrier in component (b) is no more than about 4:1.
Embodiment 19B. The composition of Embodiment 19A wherein the weight ratio of the water-immiscible liquid constituent to the solid carrier in component (b) is no more than about 3:1.
Embodiment 19C. The composition of Embodiment 19B wherein the weight ratio of the water-immiscible liquid constituent to the solid carrier in component (b) is no more than about 2:1.
Embodiment 20. The composition described in the Summary of the Invention or any one of Embodiments 1 through 19C wherein the weight ratio of the water-immiscible liquid constituent of component (b) to component (a) (i.e. the one or more carboxamide arthropodicides) is at least about 1:1.
Embodiment 20A. The composition of Embodiment 20 wherein the weight ratio of the water-immiscible liquid constituent of component (b) to component (a) is at least about 3:1.
Embodiment 20B. The composition of Embodiment 20A wherein the weight ratio of the water-immiscible liquid constituent of component (b) to component (a) is at least about 4:1.
Embodiment 21. The composition described in the Summary of the Invention or any one of Embodiments 1 through 20B wherein the weight ratio of the water-immiscible liquid constituent of component (b) to component (a) is no more than about 40:1.
Embodiment 21A. The composition of Embodiment 21 wherein the weight ratio of the water-immiscible liquid constituent of component (b) to component (a) is no more than about 20:1.
Embodiment 21B. The composition of Embodiment 21A wherein the weight ratio of the water-immiscible liquid constituent of component (b) to component (a) is no more than about 10:1.
Embodiment 22. The composition described in the Summary of the Invention or any one of Embodiments 1 through 21B wherein the water-immiscible liquid constituent of component (b) is at least about 1% of the composition by weight.
Embodiment 22A. The composition of Embodiment 22 wherein the water-immiscible liquid constituent of component (b) is at least about 10% of the composition by weight.
Embodiment 22B. The composition of Embodiment 22A wherein the water-immiscible liquid constituent of component (b) is at least about 30% of the composition by weight.
Embodiment 22C. The composition of Embodiment 22B wherein the water-immiscible liquid constituent of component (b) is at least about 35% of the composition by weight.
Embodiment 23. The composition described in the Summary of the Invention or any one of Embodiments 1 through 22C wherein the water-immiscible liquid constituent of component (b) is no more than about 40% of the composition by weight.
Embodiment 24. The composition described in the Summary of the Invention or any one of Embodiments 1 through 23 wherein component (b) is at least about 5% of the composition by weight.
Embodiment 24A. The composition of Embodiment 24 wherein component (b) is at least about 20% of the composition by weight.
Embodiment 25. The composition described in the Summary of the Invention or any one of wherein component (b) is no more than about 70% of the composition by weight.
Embodiment 25A. The composition of Embodiment 25 wherein component (b) is no more than about 60% of the composition by weight.
Embodiment 26. The composition described in the Summary of the Invention or any one of Embodiments 1 through 25A wherein component (c) (i.e. the surfactant component having dispersing and wetting properties) comprises one or more surfactants selected from the group consisting of alkylnaphthalenesulfonates (i.e. salts of alkylnapthalenesulfonic acids), salts of naphthalene formaldehyde condensate sulfonates (i.e. salts of sulfonated naphthalene formaldehyde condensates), and lignosulfonates (i.e. salts of lignosulfonic acid).
Embodiment 26A. The composition of Embodiment 26 wherein component (c) comprises one or more lignosulfonates.
Embodiment 26B. The composition of Embodiment 26A wherein component (c) comprises one or more sodium, potassium or calcium lignosulfonates.
Embodiment 27. The composition described in the Summary of the Invention or any one of Embodiments 1 through 26B wherein component (c) is at least about 1% of the composition by weight.
Embodiment 27A. The composition of Embodiment 27 wherein component (c) is at least about 5% of the composition by weight.
Embodiment 28. The composition described in the Summary of the Invention or any one of Embodiments 1 through 27A wherein component (c) is no more than about 30% of the composition by weight.
Embodiment 28A. The composition of Embodiment 28 wherein component (c) is no more than about 15% of the composition by weight.
Embodiment 29. The composition described in the Summary of the Invention or any one of Embodiments 1 through 28A wherein component (d) (i.e. the one or more additional formulating ingredients) comprises one or more formulating ingredients selected from the group consisting of lubricants, anticaking agents, chemical stabilizers and solid diluents.
Embodiment 29A. The composition described in the Summary of the Invention or any one of Embodiments 1 through 29 wherein component (d) comprises one or more formulating ingredients selected from the group consisting of grinding agents, binders and water-soluble diluents.
Embodiment 29B. The composition described in the Summary of the Invention or any one of Embodiments 1 through 29A wherein component (d) comprises one or more clays in an amount ranging from about 1 to about 15% of the composition by weight.
Embodiment 29C. The composition described in the Summary of the Invention or any one of Embodiments 1 through 29B wherein component (d) comprises one or more saccharides in an amount ranging from about 1 to about 85% of the composition by weight.
Embodiment 29D. The composition of Embodiment 29C wherein component (d) comprises one or more saccharides in an amount ranging from about 5 to about 35% of the composition by weight.
Embodiment 29E. The composition of Embodiment 29D wherein component (d) comprises one or more saccharides in an amount ranging from about 5 to about 25% of the composition by weight.
Embodiment 29F. The composition of Embodiment 29C wherein component (d) comprises lactose monohydrate in an amount ranging from about 1 to about 80% of the composition by weight.
Embodiment 29G. The composition of Embodiment 29F wherein component (d) comprises lactose monohydrate in an amount ranging from about 1 to about 35% of the composition by weight.
Embodiment 29H. The composition of Embodiment 29G wherein component (d) comprises lactose monohydrate in an amount ranging from about 1 to about 25% of the composition by weight.
Embodiment 29I. The composition of Embodiment 29C wherein component (d) comprises sucrose in an amount ranging from about 0.1 to about 5% of the composition by weight.
Embodiment 30. The composition described in the Summary of the Invention or any one of Embodiments 1 through 291 wherein component (d) is at least about 5% of the composition by weight.
Embodiment 31. The composition described in the Summary of the Invention or any one of Embodiments 1 through 30 wherein component (d) is no more than about 40% of composition by weight.
Embodiment 31A. The composition of Embodiment 31 wherein component (d) is no more than about 30% of the composition by weight.
Embodiments of this invention can be combined in any manner.

The term “carboxamide arthropodicide” in the present context denotes a compound useful for controlling arthropod pests which comprises one or more carboxamide moieties in its molecular structure. Because carboxamide moieties are polar and support hydrogen-bonding, carboxamide arthropodicides are typically crystalline solids in their pure form at room temperature (e.g., 20° C.). Therefore typically at least one of the one or more carboxamide arthropodicides of component (a) has a melting point higher than about 20° C., more typically higher than about 50° C., more typically higher than about 80° C., even more typically above about 100° C., and most typically above about 120, 160, 180 or even 200° C. Often all of the one or more carboxamide arthropodicides of component (a) have melting points higher than about 80° C., above about 100° C., or even above about 120, 160, 180 or even 200° C. Typically the one or more carboxamide arthropodicides of component (a) have water solubility less than about 10 g/L and more typically less than about 5 g/L.

As is well known in the art, the term “carboxamide” refers to a moiety comprising a carbon, nitrogen and oxygen atom bonded in the configuration shown as Formula A. The carbon atom in Formula A is bonded to a carbon atom in a radical to which the carboxamide moiety is bonded. The nitrogen atom in Formula A is bonded to the carbonyl carbon of Formula A and also bonded to two other atoms, at least one atom of which is selected from a hydrogen atom or a carbon atom of another radical to which the carboxamide moiety is bonded.

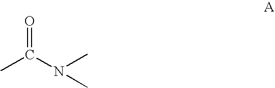

In one embodiment the present compositions comprise at least one carboxamide arthropodicide that is solid at room temperature and contains at least two carboxamide moieties. In another embodiment at least one carboxamide arthropodicide contains at least two carboxamide moieties vicinally bonded to carbon atoms (i.e. in ortho arrangement, and in other words, two vicinal carboxamide moieties bonded to carbon atoms) of a carbocyclic or heterocyclic ring. Thereby each carboxamide moiety can be independently bonded through the carbonyl carbon of Formula A or the nitrogen atom of Formula A to a carbon atom of the carbocyclic or heterocyclic ring. Accordingly each carboxamide moiety in the vicinal arrangement can be bonded through the carbonyl carbon, or each carboxamide moiety can be bonded through the nitrogen atom, or one carboxamide moiety can be bonded through the carbonyl carbon and the other carboxamide moiety can be bonded through the nitrogen atom. The presence of two vicinal carboxamide moieties in the molecular structure can provide strong crystal lattice attractions and relatively high melting points. In a further embodiment the carbocyclic or heterocyclic ring of at least one carboxamide arthropodicide is aromatic (i.e. satisfies the Hückel 4n+2 rule for aromaticity).

Of particular note as carboxamide arthropodicides useful in compositions of the present invention are those of Formula 1, N-oxides and salts thereof, and Formula 2 and salts thereof

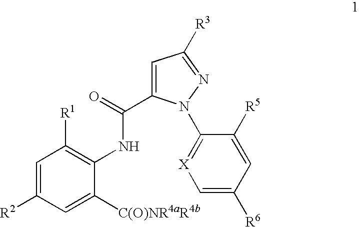

wherein
X is N, CF, CCl, CBr or CI;
R¹ is CH₃, Cl, Br or F;
R² is H, F, Cl, Br or —CN;
R³ is F, Cl, Br, C₁-C₄ haloalkyl or C₁-C₄ haloalkoxy;
R^{4a} is H, C₁-C₄ alkyl, cyclopropylmethyl or 1-cyclopropylethyl;
R^{4b} is H or CH₃;
R⁵ is H, F, Cl or Br; and
R⁶ is H, F, Cl or Br.

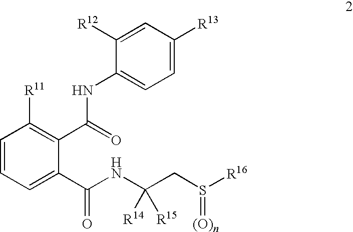

wherein
R¹¹ is CH₃, Cl, Br or I;
R¹² is CH₃ or Cl;
R¹³ is C₁-C₃ fluoroalkyl;
R¹⁴ is H or CH₃;
R¹⁵ is H or CH₃;
R¹⁶ is C₁-C₂ alkyl; and
n is 0, 1 or 2.

In the above recitations, the term “alkyl”, used either alone or in compound words such as “haloalkyl” or “fluoroalkyl” includes straight-chain or branched alkyl, such as, methyl, ethyl, n-propyl, i-propyl, or the different butyl isomers. “Alkoxy” includes, for example, methoxy, ethoxy, n-propyloxy, isopropyloxy and the different butoxy isomers. The term “halogen”, either alone or in compound words such as “haloalkyl”, includes fluorine, chlorine, bromine or iodine. Further, when used in compound words such as “haloalkyl” or “haloalkoxy”, said alkyl may be partially or fully substituted with halogen atoms which may be the same or different. Examples of “haloalkyl” include CF₃, CH₂Cl, CH₂CF₃ and CCl₂CF₃. The terms “haloalkoxy”, and the like, are defined analogously to the term “haloalkyl”. Examples of “haloalkoxy” include OCF₃, OCH₂Cl₃, OCH₂CH₂CHF₂ and OCH₂CF₃.

The total number of carbon atoms in a substituent group is indicated by the “Cᵢ-Cⱼ” prefix where i and j are numbers from 1 to 4. For example, C₁-C₄ alkyl designates methyl through butyl, including the various isomers.

Compounds of Formula 1 and Formula 2 wherein substituents are as specified above each have vicinal carboxamide substituents bonded to the carbon atoms of a phenyl ring. In Formula 1 one carboxamide moiety is bonded through the carbonyl carbon and the other carboxamide moiety is bonded through the nitrogen atom, and in Formula 2 both carboxamide moieties are bonded through the carbonyl carbon to the phenyl ring supporting the vicinal positioning of the carboxamide moieties. The arthropodicidal activity of the Formula 1 and Formula 2 compounds is believed to involve binding to ryanodine receptors in muscle cells, causing the channel to open and release calcium ions into the cytoplasm. Depletion of calcium ion stores results in arthropod paralysis and death. Accordingly, carboxamide arthropodicide compounds of Formulae 1 and 2 are described as ryanodine receptor ligands. PCT Publication WO 2004/027042 describes an assay for ryanodine receptor ligands. Partly because of the two carboxamide moieties in their molecular structures, compounds of Formulae 1 and 2 in their pure states are typically crystalline solids with relatively high melting points, i.e. above about 150° C., and often above even 200° C. Accordingly, the composition of the present invention can facilitate the arthropodicidal efficacy of these compounds. Therefore of note is the composition of the present invention wherein component (a) (i.e. the one or more carboxamide arthropodicides) comprises at least one carboxamide arthropodicide that is a ryanodine receptor ligand. Also of note is the composition of the present invention wherein component (a) is selected from carboxamide arthropodicides that are ryanodine receptor ligands. Compounds of Formulae 1 and 2 and methods for their preparation are reported in the patent literature; see, for example, U.S. Pat. No. 6,747,047, and PCT Publications WO 2003/015518, WO 2003/015519 and WO 2004/067528 regarding Formula 1, and U.S. Pat. No. 6,603,044 regarding Formula 2.

Of particular note is the composition described in the Summary of the Invention wherein component (a) (i.e. the one or more carboxamide arthropodicides) comprises a carboxamide arthropodicide selected from the group consisting of:
3-bromo-1-(3-chloro-2-pyridinyl)-N-[4-cyano-2-methyl-6-[(methylamino)carbonyl]-phenyl]-1H-pyrazole-5-carboxamide (Formula 1),
3-bromo-N-[4-chloro-2-methyl-6-[(methylamino)carbonyl]phenyl]-1-(3-chloro-2-pyridinyl)-1H-pyrazole-5-carboxamide (Formula 1),
N-[4-chloro-2-methyl-6-[[(1-methylethyl)amino]carbonyl]phenyl]-1-(3-chloro-2-pyridinyl)-3-(trifluoromethyl)-1H-pyrazole-5-carboxamide (Formula 1),
N-[4-chloro-2-methyl-6-[(methylamino)carbonyl]phenyl]-1-(3-chloro-2-pyridinyl)-3-(trifluoromethyl)-1H-pyrazole-5-carboxamide (Formula 1),
3-bromo-N-[4-chloro-2-methyl-6-[[(1-methylethyl)amino]carbonyl]phenyl]-1-(3-chloro-2-pyridinyl)-1H-pyrazole-5-carboxamide (Formula 1),
1-(3-chloro-2-pyridinyl)-N-[4-cyano-2-methyl-6-[(methylamino)carbonyl]phenyl]-3-(trifluoromethyl)-1H-pyrazole-5-carboxamide (Formula 1),
3-bromo-1-(2-chlorophenyl)-N-[4-cyano-2-methyl-6-[[(1-methylethyl)amino]-carbonyl]-phenyl]-1H-pyrazole-5-carboxamide (Formula 1),
3-bromo-1-(2-chlorophenyl)-N-[4-cyano-2-methyl-6-[(methylamino)carbonyl]phenyl]-1H-pyrazole-5-carboxamide (Formula 1),
3-bromo-1-(2-chlorophenyl)-N-[2,4-dichloro-6-[(methylamino)carbonyl]phenyl]-1H-pyrazole-5-carboxamide (Formula 1),
3-bromo-N-[4-chloro-2-[[(cyclopropylmethyl)amino]carbonyl]-6-methylphenyl]-1-(3-chloro-2-pyridinyl)-1H-pyrazole-5-carboxamide (Formula 1),
3-bromo-1-(3-chloro-2-pyridinyl)-N-[4-cyano-2-[[(cyclopropylmethyl)amino]-carbonyl]-6-methylphenyl]-1H-pyrazole-5-carboxamide (Formula 1),
3-bromo-N-[4-chloro-2-[[(1-cyclopropylethyl)amino]carbonyl]-6-methylphenyl]-1-(3-chloro-2-pyridinyl)-1H-pyrazole-5-carboxamide (Formula 1),
3-bromo-1-(3-chloro-2-pyridinyl)-N-[4-cyano-2-[[(1-cyclopropylethyl)amino]carbonyl]-6-methylphenyl]-1H-pyrazole-5-carboxamide (Formula 1), and
N²-[1,1-dimethyl-2-(methylsulfonyl)ethyl]-3-iodo-N¹-[2-methyl-4-[1,2,2,2-tetrafluoro-1-(trifluoromethyl)ethyl]phenyl]-1,2-benzenedicarboxamide (Formula 2).

Of particular note as carboxamide arthropodicides in the present composition are 3-bromo-1-(3-chloro-2-pyridinyl)-N-[4-cyano-2-methyl-6-[(methylamino)carbonyl]phenyl]-1H-pyrazole-5-carboxamide and 3-bromo-N-[4-chloro-2-methyl-6-[(methylamino)carbonyl]-phenyl]-1-(3-chloro-2-pyridinyl)-1H-pyrazole-5-carboxamide.

The carboxamide arthropodicides (e.g., Formula 1) in the present compositions can also be in the form of N-oxides. One skilled in the art will appreciate that not all nitrogen-containing heterocyclic rings can form N-oxides since the nitrogen requires an available lone pair for oxidation to the oxide; one skilled in the art will recognize those nitrogen-containing heterocyclic rings which can form N-oxides. One skilled in the art will also recognize that tertiary amines can form N-oxides. Synthetic methods for the preparation of N-oxides of heterocyclic rings and tertiary amines are very well known by one skilled in the art including the oxidation of heterocyclic rings and tertiary amines with peroxy acids such as peracetic and m-chloroperbenzoic acid (MCPBA), hydrogen peroxide, alkyl hydroperoxides such as t-butyl hydroperoxide, sodium perborate, and dioxiranes such as dimethyldioxirane. These methods for the preparation of N-oxides have been extensively described and reviewed in the literature, see for example: T. L. Gilchrist in Comprehensive Organic Synthesis, vol. 7, pp 748-750, S. V. Ley, Ed., Pergamon Press; M. Tisler and B. Stanovnik in Comprehensive Heterocyclic Chemistry, vol. 3, pp 18-20, A. J. Boulton and A. McKillop, Eds., Pergamon Press; M. R. Grimmett and B. R. T. Keene in Advances in Heterocyclic Chemistry, vol. 43, pp 149-161, A. R. Katritzky, Ed., Academic Press; M. Tisler and B. Stanovnik in Advances in Heterocyclic Chemistry, vol. 9, pp 285-291, A. R. Katritzky and A. J. Boulton, Eds., Academic Press; and G. W. H. Cheeseman and E. S. G. Werstiuk in Advances in Heterocyclic Chemistry, vol. 22, pp 390-392, A. R. Katritzky and A. J. Boulton, Eds., Academic Press.

One skilled in the art recognizes that because in the environment and under physiological conditions salts of chemical compounds are in equilibrium with their corresponding nonsalt forms, salts share the biological utility of the nonsalt forms. Thus a wide variety of salts of carboxamide arthropodicides (e.g., Formulae 1 or 2) are useful in the present compositions (i.e. are agriculturally suitable). Such salts include acid-addition salts with inorganic or organic acids such as hydrobromic, hydrochloric, nitric, phosphoric, sulfuric, acetic, butyric, fumaric, lactic, maleic, malonic, oxalic, propionic, salicylic, tartaric, 4-toluenesulfonic or valeric acids. Salts can also include those formed with organic bases (e.g., pyridine, triethylamine or ammonia) or inorganic bases (e.g., hydrides, hydroxides or carbonates of sodium, potassium, lithium, calcium, magnesium or barium) when the carboxamide arthropodicide contains an acidic moiety such as a carboxylic acid or phenol.

Although component (a) (i.e. the one or more carboxamide arthropodicides) can range from about 0.1 to about 50% of the present composition by weight, the present composition typically comprises from about 1% to about 20%, more typically from about 1% to about 10% of the composition by weight.

In the composition of the present invention, component (b) is a particulate component comprising particles of a solid carrier infiltrated with a water-immiscible liquid constituent. Although the composition of the present invention generally comprises component (b) in an amount ranging from about 0.5 to about 95% of the composition by weight, more typically component (b) amounts to from about 5% to about 70% and most typically component (b) amounts to from about 20% to about 60% of the composition by weight.

The term “water-immiscible liquid constituent” as used herein refers to a chemical compound or mixture of chemical compounds that is liquid at 20° C. and is soluble in water to an extent less than about 2% by weight at 20° C. Low solubility of liquid compounds in water is a result of low molecular polarity. As the low molecular polarity of water-immiscible liquids is closer than the very high polarity of water to the moderate polarity of carboxamide arthropodicides, carboxamide arthropodicides generally are more soluble in water-immiscible liquids than in water, in which they have little solubility. The greater solubility of carboxamide arthropodicides in water-immiscible liquids can promote uptake of the carboxamide arthropodicides by facilitating contact with the leaf cuticle. Nevertheless, as the water-immiscible liquid constituent is present in relatively limited amount in the composition of the present invention and furthermore is infiltrated into solid carrier particles, the improved arthropodicidal efficacy provided by the present composition is particularly surprising.

Transfer of a carboxamide arthropodicide to a leaf cuticle is facilitated by contact of the water-immiscible liquid constituent with both the carboxamide arthropodicide and the leaf cuticle. To maintain contact, the water-immiscible liquid constituent is desirably relatively nonvolatile. In the context of the present disclosure and claims, the term “relatively nonvolatile” means the water-immiscible liquid constituent has a normal boiling point of at least about 200° C. Preferably the water-immiscible liquid constituent has a normal boiling point of at least about 250° C., and more preferably at least about 280° C. As is well known in the art, the normal boiling point is the boiling point at 101 kPa.

In one embodiment of the present compositions the water-immiscible liquid constituent has a viscosity below 50 cP at 20° C., which can facilitate absorption of the water-immiscible liquid constituent into the solid carrier particles. In another embodiment of the present compositions, the water-immiscible liquid constituent has a flash point above 65° C. and/or low toxicity, both properties providing safety benefits.

A wide range of water-immiscible liquid compounds are useful in forming the water-immiscible liquid constituent in the composition of present invention. Typically the water-immiscible compounds are organic compounds (i.e. contain one or more carbon atoms). Water-immiscible liquid compounds most effective under particular range of conditions (e.g., carboxamide arthropodicides, arthropod pest species to be controlled, plant species to be protected, environmental conditions) can be easily determined through simple experimentation. Generally useful as water-immiscible liquids in the present composition are fatty esters of C₁-C₄ alkanols (including those derived from seed and fruit oils), seed and fruit oils and mineral oils. Not only do these particular water-immiscible liquids have low polarity, water solubility and work well in the present compositions, but they are relatively nontoxic and are readily available from commercial sources at moderate cost.

Mineral oil, also known as liquid petrolatum, liquid paraffin, paraffin oil and paraffinic oil, comprises a mixture of long-chain, liquid hydrocarbons obtained from petroleum. Mineral oils can be obtained commercially from many sources, either as a straight mineral oil or blended with emulsifiers, for example, ISOPAR H (Deutsche Exxon Chemicals) or SUREMIX (DuPont, USA).

Seed and fruit oils, i.e. vegetable oils, are oils obtained from plants. Vegetable oils are typically obtained by pressing or solvent extracting seeds (e.g., sunflower, rapeseed, soybean, corn (maize), linseed (flax)) or fruits (e.g., olive). Examples of vegetable oils that are commercially available at moderate cost are sunflower oil, rapeseed oil, canola oil, soybean oil and corn oil. Vegetable oil mostly comprises fatty acid glycerides, i.e. glycerol esters of fatty acids.

Fatty acid esters of C₁-C₄ alkanols (i.e. fatty acids esterified with C₁-C₄ alkanols instead of glycerol) have lower viscosities than vegetable oils and thus are particularly useful in forming the water-immiscible liquid constituent of the present compositions.

The fatty acid portions of the fatty acid esters consist of a carboxylate moiety bound to a hydrocarbon chain, which can be unbranched or branched, but are typically unbranched in natural sources. The hydrocarbon chain can be saturated or unsaturated; typically the hydrocarbon chain is saturated (i.e. alkyl) or contains 1 or 2 carbon-carbon double bonds (i.e. alkenyl). Fatty acid esters formed from fatty acids containing either an odd number of carbon atoms (i.e. even number of carbon atoms in the hydrocarbon chain) or an even number of carbon atoms (i.e. odd number of carbon atoms in the hydrocarbon chain) are useful in the compositions of the present invention. Although esters of lower fatty acids (e.g., containing as few a 4 carbon atoms) can be included in the present compositions, they are preferably mixed with esters of higher fatty acids to decrease polarity, water solubility and volatility, and esters of fatty acids having at least 10 carbon atoms can have favorable physical properties. As fatty acids obtained from natural sources typically contain an even number of carbon atoms ranging from 10 to 22 carbon atoms, alkanol esters of these fatty acids are of note for reasons of commercial availability and cost. The C₁₀-C₂₂ fatty acid esters with an even number of carbon atoms are, for example, erucic acid, lauric acid, palmitic acid, stearic acid, oleic acid, linoleic acid and linolenic acid. Of note are one or more fatty acid esters in the compositions of the present invention, which comprise esters of fatty acids containing 12 to 20 carbon atoms. Of further note are compositions of the present invention wherein the water-immiscible liquid constituent comprises an ester of a fatty acid containing 16 to 18 carbon atoms.

The C₁-C₄ alkanol-derived portions of the fatty acid esters can be unbranched (i.e. straight-chain) or branched, but are typically unbranched. For reasons including favorable physical properties, commercial availability and cost, of note are the fatty acid esters which are fatty acids esterified with C₁-C₂ alkanols, and of further note are the fatty acid esters which are fatty acids esterified with C₁ alkanol (i.e. methanol). The fatty acid alkanol esters in a composition of the present invention can also be derived from a mixture of alcohols (e.g., methanol and ethanol).

Fatty acid compositions obtained from natural sources (e.g., seed oils) typically consist of fatty acids having a range of chain lengths and different degrees of unsaturation. Fatty acid ester compositions derived from such fatty acid mixtures can be useful in the compositions of the present invention without need to first separate the fatty acid esters. Suitable fatty acid ester compositions obtained from plants include seed and fruit oils of sunflower, rapeseed, olive, corn, soybean, cotton and linseed, and also oil palm. Of note is a composition of the invention wherein the water-immiscible liquid comprises fatty acid methyl esters derived from seed oils of sunflower, soybean, cotton or linseed. Also of note is a composition of the invention wherein the water-immiscible liquid comprises fatty acid methyl esters derived from seed oils of oil palm, sunflower, soybean, cotton, rapeseed or linseed, particularly oil palm, sunflower, soybean, cotton or rapeseed, and more particularly soybean or rapeseed. Of particular note is a composition of the invention wherein the water-immiscible liquid comprises fatty acid methyl esters derived from soybean oil (also known as methylated soybean oil or methyl soyate).

Fatty acid esters of alkanols and methods for their preparation are well known in the art. For example, “biodiesel” typically comprises fatty acid esters of ethanol or more commonly methanol. Two principal routes used to prepare fatty acid alkanol esters are transesterification starting with another fatty acid ester (often a naturally occurring ester with glycerol) and direct esterification starting with the fatty acid. A variety of methods are known for these routes. For example, direct esterification can be accomplished by contacting a fatty acid with an alkanol in the presence of a strong acid catalyst such as sulfuric acid. Transesterification can be accomplished by contacting a starting fatty acid ester with the alcohol in the presence of a strong acid catalyst such as sulfuric acid but more commonly a strong base such as sodium hydroxide.

Alkylated seed oils are the transesterification products of seed oils with an alkanol. For example methylated soybean oil, also known as methyl soyate, comprises methyl esters produced by the transesterification of soybean oil with methanol. Methyl soyate thus comprises methyl esters of fatty acids in the approximate molar ratio that the fatty acids occur esterified with glycerol in soybean seed oil. Alkylated seed oils such as methyl soyate can be distilled to modify the proportion of methyl fatty acid esters.

In the composition of the present invention the water-immiscible liquid constituent is infiltrated (i.e. absorbed) into particles of the solid carrier. The carrier provides support for the water-immiscible liquid constituent and also provides mechanical strength during further formulation processing, e.g., milling, granulation. Therefore solid carriers are formed from porous absorptive materials. The composition of the present invention is typically not used as an arthropodicidal bait, and the carrier typically does not comprise food materials attractive to arthropod pests. To absorb a desired amount of the water-immiscible liquid constituent the solid carrier needs to have sufficient internal surface area and intrusion volume to accommodate the water-immiscible liquid constituent and also a large enough pore diameter to facilitate absorption of the water-immiscible liquid constituent. Typically the intrusion volume is between 1 and 20 cm³/g, more typically between 3 and 10 cm³/g and most typically between 5 and 10 cm³/g. The internal surface area is typically between 20 and 400 m²/g and more typically between 100 and 200 m²/g. The mean pore diameter is typically between 0.05 and 2 μm, more typically between 0.05 and 1 μm, and most typically between 0.1 and 0.5 μm. Classes of materials with such properties include precipitated, amorphous and fumed silicas, silicates of lithium, sodium, magnesium, potassium, calcium and aluminum, diatomaceous earths, and bentonite, kaolin and attapulgite clays. Examples of silicas include Degussa FK-35, SIPERNAT D-17, SIPERNAT 22 and SIPERNAT 50S (all precipitated silicas), Degussa AEROSIL 200 (a fumed silica), Davison SYLOID 244 (an amorphous silica), Johns-Manville CELITE 209 (diatomaceous earth). Examples of silicates include Johns-Manville MICROCEL E (calcium silicate), Huber HUBERSORB 600 (precipitated amorphous calcium silicate), Harbourlite Perlite 2005 (amorphous aluminum silicate) and Huber ZEOLEX 7A (sodium silicate). Examples of clays include American Colloid VOLCLAY 325 (bentonite), Huber Barden clay (kaolin) and Englehard MICROSORB LVM (attapulgite).

Solid carriers comprising a silica compound (i.e. a silica or silicate) work particularly well in component (b) of the composition of the present invention. Therefore of note is the composition of the invention wherein the solid carrier in component (b) comprises at least one silica or silicate selected from the group consisting silicas and silicates of lithium, sodium, potassium, magnesium, calcium and aluminum (including mixtures thereof), and particularly of magnesium, calcium and aluminum (including mixtures thereof). Of particular note is calcium silicate, which is commercially available in forms (e.g., MICROCEL E) with pore size and other properties making it especially useful as a solid carrier in component (b) of the present composition.

Depending upon formulation processing, application and use of the composition, the water solubility of solid carrier in component (b) may or may not be important. If the solid carrier is readily soluble in water, dilution of the composition in water prior to spraying will typically form an emulsion of the water-immiscible liquid constituent instead of a dispersion of particles of the solid carrier infiltrated with the water-immiscible liquid constituent. Nevertheless, the emulsion can still provide good arthropodicidal efficacy. If formulation processing involves water, such as for granulating a wettable powder, the solid carrier in component (b) should be relatively water insoluble. Typically the solid carrier in component (b) of the present composition is relatively water insoluble. The expression “relatively water insoluble” in the context of the present disclosure and claims means that stirring the solid carrier in powder form in water at 20° C. for 6 h results in no more than 10 g of solid carrier dissolving in 1 L of water. Preferably under these conditions no more than about 5 g, and more preferably no more than about 2 or 1 g of solid carrier dissolves in 1 L of water. Clays, silicas and silicates of magnesium, calcium and aluminum typically have water solubility of less than, and often much less than, 2 g per L.

Pore diameter places a lower limit on particle size, as particles cannot be smaller than their pores. Therefore typically the mean particle size (i.e. volume moment mean, De Brouker mean) of the particles of the solid carrier is at least 0.1 μm and more typically at least 5 μm. The speed of absorption of the water-immiscible liquid constituent may decrease with increasing particle size due to increasing distance between the particle surface and center. Furthermore, if the diluted composition is to be sprayed, the particles in the composition must be smaller than the spray head orifice. Therefore typically the mean particle size of the particles of the solid carrier is no more than 200 μm and more typically no more than 20 μm.

Typically the weight ratio of water-immiscible liquid constituent to the solid carrier in component (b) is at least 1:3. Greater ratios such as 1:2 and 2:3 may be desirable to provide a higher concentration of water-immiscible liquid in the composition. The greatest ratio achievable with commercially available materials is typically about 5:1, and depending upon the materials, the limit may be a lesser ratio such as 4:1, 3:1 or 2:1. Typically the weight ratio of the water-immiscible constituent of component (b) to component (a) is at least 1:1, and higher ratios such as 3:1 and 4:1 may provide better arthropodicidal efficacy. Typically the weight ratio of the water-immiscible constituent of component (b) to component (a) is no more than 40:1, more typically no more than 20:1 and most typically no more than 10:1. The water-immiscible liquid is typically present in an amount from about 1 to about 40% by weight, more typically from about 10 to about 40% by weight, or about 30 to about 40% by weight, and most typically from about 35 to about 40% by weight based on the total weight of the composition.

In the composition of the present invention, component (c) is a surfactant component having dispersing and wetting properties. Although the composition of the present invention generally comprises component (c) in an amount ranging from about 0.1% to about 50% of the composition by weight, more typically component (c) amounts to from about 1% to about 30% and most typically component (b) amounts to from about 5% to about 15% of the composition by weight.

As generally understood in the art of formulation, the term “surfactant” means “surface-active agent” and refers to a chemical substance or mixture of chemical substances that when added to a liquid changes the properties of that liquid at a surface. The change in properties generally comprises change, typically reduction, in surface tension. In the present compositions the surfactant component (c) has both dispersing and wetting properties. Surfactant component (c) may also have other properties known for surfactants, such as defoaming effect. The dispersing property of surfactants reduces the cohesive attraction between particles of similar composition and thus the tendency of particles to stick together after dilution with water. Particles sticking together results in formation of agglomerates that do not disperse well in water. Dispersants, also called dispersing agents, can reduce attractive forces between particles in close proximity. The wetting property of surfactants increases the ability of a liquid to spread and penetrate by lowering the liquid's surface tension. Wetting as well as dispersing properties facilitate forming aqueous dispersions of particles from solid formulations. Wetting agents can also help spread spray mixtures across foliage surfaces to provide better coverage. Some surfactants have both dispersing and wetting properties. However, usually a surfactant will be most useful for either a dispersing or a wetting effect. Therefore typically the surfactant component (c) comprises a least two surfactants, at least one of which is regarded as a dispersant and at least one of which is regarded as a wetting agent.

A wide variety of dispersants and wetting agents are known in the art of formulation, including those described in McCutcheon's Detergents and Emulsifiers Annual, Allured Publ. Corp., Ridgewood, N.J., as well as Sisely and Wood, Encyclopedia of Surface Active Agents, Chemical Publ. Co., Inc., New York, 1964. Examples of dispersants include, but are not limited to, sodium, calcium and ammonium salts of lignosulfonates (optionally polyethoxylated) (e.g., MARASPERSE N22), formaldehyde condensates of naphthalene-sulfonates or alkylnaphthalenesulfonates (e.g., MORWET D425), condensed methylnaphthalenesulfonates (e.g., SUPRAGIL MNS/90), anionic condensation products of alkylphenol, formaldehyde and optionally sodium sulfite, salts of polycarboxylic acids (e.g., polyacrylic acids and copolymers) (e.g., METASPERSE 550), phosphate esters of tristyrylphenol ethoxylates (e.g., SOPROPHOR 3D33), polyethylene/polypropylene block polymers (e.g., PLURONIC F108, ATLOX 4912, ATLAS G-5000, SYNPERONIC PE series copolymers) and ethylene oxide-propylene oxide based acrylic acid graft copolymers such as methyl methacrylate graft copolymers (e.g., ATLOX 4913). Examples of wetting agents include, but are not limited to, alkyl sulfosuccinates (e.g., AEROSOL OTB), laurates, sulfate and phosphate esters of long chain alcohols, acetylenic diols, ethoxyfluorinated alcohols, ethoxylated silicones, alkyl phenol ethoxylates, benzene sulfonates, alkyl-substituted benzene sulfonates such as sodium dodecylbenzenesulfonates (e.g., RHODACAL DS10), alkyl α-olefin sulfonates, naphthalene sulfonates, alkyl-substituted naphthalene sulfonates (e.g., MORWET EFW), and alcohol ethoxylates.

Particularly useful dispersants for the compositions of the present invention include lignosulfonate salts such as MARASPERSE N22, anionic salts of acrylic acid polymers and copolymers such as METASPERSE 550 and alkyl naphthalene sulfonate formaldehyde condensates such as MORWET D425. Particularly useful wetting agents for the compositions of the present invention include anionic alkyl-substituted naphthalene sulfonates such as MORWET EFW, anionic sulfates of long chain alcohols, alkyl sulfosuccinates such as AEROSOL OTB, alkyl-substituted benzene sulfonates such as sodium dodecylbenzene sulfonate (RHODACAL DS10).

In the composition of the present invention, component (d) comprises one or more additional formulating ingredients. Although component (d) is optional (i.e. may be 0% of the present composition), typically the composition comprises at least about 5% of component (d) by weight. Although generally the composition of the present invention may comprise up to about 99.3% of component (d) by weight, typically component (d) amounts to no more than about 40%, more typically no more than about 30% of the composition by weight. The additional formulating ingredients of component (d) may be selected from the wide variety of ingredients known in the art of formulation. Many of these ingredients are described in McCutcheon's 2001 Volume 2: Functional Materials published by MC Publishing Company. Additional formulating ingredients include, for example, lubricants, anticaking agents, chemical stabilizers and solid diluents. Additional formulating ingredients particularly useful in forming the present compositions are solid diluents that are grinding aids, binders and water-soluble diluents (other than binders).

Grinding aids are typically brittle, non-smearing inorganic chemicals such as clays, silicas and diatomaceous earths. Grinding aids prevent build-up in mechanical impact mills. Particularly useful grinding aids in the compositions of the present invention are Barden clay, bentonite clays, attapulgite clays, and precipitated and fumed silicas. The composition of the present invention typically comprises from about 1% to about 15% of one or more grinding agents by weight of composition. Typically the one or more grinding agents in the present composition are selected from clays.

Binders increase the mechanical strength of granules by binding formulation components together. A wide variety of binders are known in the art of formulation. Particularly useful binders in the compositions of the present invention are certain saccharides and modified saccharides. These include certain sugars (e.g., sucrose), sugar derivatives (e.g., mannitol) and starches and modified starches such as dextrin. Dextrin is produced by dry roasting starch alone or in the presence of trace levels of acid catalysts (which causes hydrolysis of the starch followed by molecular rearrangement and combination of the resulting fragments). Particularly useful dextrins are yellow dextrins, which are available from many commercial sources. Yellow dextrins are typically obtained by dry roasting starch, often at temperatures above 150° C., in the presence of trace levels of acid catalysts. Yellow dextrins are yellowish powders that are substantially soluble in water near room temperature. Optimal amounts of binders can be determined by simple experimentation. When sucrose is used as the binder, it is typically included in the present composition in an amount from about 0.1% and about 5% by weight of the composition.

Water-soluble diluents rapidly dissolve in water, and thus expose the water-dispersible or soluble skeleton of the granule to water and accelerate granule break-up and dispersion. A wide range of water-soluble diluents are known in the art of formulation. These include salts or carbohydrates that dissolve rapidly in water; non-limiting examples include alkali metal phosphates, alkaline earth phosphates, sulfates of sodium, potassium, magnesium and zinc, sodium and potassium chloride, sodium benzoate, lactose and sucrose. Many of the saccharide and modified saccharide binders are water-soluble and thus promote granule break-up and dispersion on contact with water. Some water-soluble diluents have only weak binding capability and thus their principal usefulness is as water-soluble diluent. A weakly binding, water-soluble diluent particularly useful in the present composition is lactose, typically in the form of lactose monohydrate. When lactose is included, it typically is in an amount (as its monohydrate) between about 1% and about 80%, more typically between about 1% and about 35%, and most typically between about 1% and 25% of the present composition by weight.

The composition of the present invention can be formed in any of the types of solid compositions commonly used for formulating arthropodicide active ingredients. These types include dusts, powders, granules, pellets, prills, pastilles, tablets and the like. Typically the composition of the present invention is first prepared as a wettable powder. The other solid compositions types can be prepared from the wettable powder using general methodologies well known in the art of formulation. For methodologies involving exposure to water, the solid carrier of component (b) should be relatively water insoluble.

A wettable powder of the composition of the present invention can be prepared by absorbing the water-immiscible liquid constituent onto the solid carrier, mixing the water-immiscible liquid-infiltrated carrier with the other formulating ingredients, and finally milling the mixture.

Although the solid carrier can be added to the water-immiscible constituent, best results are typically achieved by slowly adding the water-immiscible liquid to the solid carrier. The mixture is then typically gently stirred using, for example, a rotary mixer at low speed until the powder infiltrated with the water-immiscible constituent becomes flowable. The water-immiscible liquid can be diluted with a volatile solvent before addition to the solid carrier, and the solvent then removed using such methods as heating and reduction of pressure; however, for most water-immiscible liquids this procedure is unnecessary and therefore not desirable in view of additional processing effort and cost.

The water-immiscible liquid-infiltrated carrier can be most conveniently mixed with other formulating ingredients using a blender. Premixing with a blender mixes the ingredients on a macro-scale before they are milled. Screw, paddle, cone and ribbon blenders are all suitable for premixing ingredients.

The main purpose of milling is to generate intimate contact between formulating ingredients. Many impact mills are suitable, for example, a hammer mill with a 300 US mesh screen.

In addition to wettable powders, granules are particularly useful types of solid compositions according to the present invention. Granules can be prepared starting from wettable powders using such well-known general methods as pan granulation, fluid-bed granulation and extrusion. These granulation methods typically comprise adding a granulation liquid such as water to the milled wettable powder, granulating according the particular method, and finally drying the granulated product. Pan granulation and fluid-bed granulation involve agglomeration techniques; see Browning, “Agglomeration”, Chemical Engineering, Dec. 4, 1967, pp 147-48, Perry's Chemical Engineer's Handbook, 4th Ed., McGraw-Hill, New York, 1963 and U.S. Pat. No. 3,920,442. Paste extrusion involves forcing a moistened mixture, typically fed by an auger, through a die using procedures analogous to those described in PCT Patent Publication WO 2004/023876. Pellets and tablets can be prepared by dry-compressing wettable powders using a briquetting press (e.g., Model 220 Komarek Roll Briquetter, K. R. Komarek Inc., Elk Grove Village, Ill., USA), roll compactor (e.g., TF-MINI, Freund Sangyo K.K.) or tablet press using procedures analogous to those described in U.S. Pat. Nos. 4,172,714, 5,180,587, 5,208,030 and 5,232,701. For recent reviews of formulation methods, see T. S. Woods, “The Formulator's Toolbox—Product Forms for Modern Agriculture” in Pesticide Chemistry and Bioscience, The Food-Environment Challenge, T. Brooks and T. R. Roberts, Eds., Proceedings of the 9th International Congress on Pesticide Chemistry, The Royal Society of Chemistry, Cambridge, 1999, pp 120-133 and Developments in Formulation Technology, PJB Publications, Richmond, UK, 2000.

Thus as described herein, the composition of the present invention comprises as one of its essential elements a particulate component comprising particles of a solid carrier infiltrated with a water-immiscible liquid constituent. Accordingly the water-immiscible liquid constituent is absorbed into pores in the solid carrier. The pores can be in the form of channels or other cavities in the solid carrier particles, but must be open to the exterior of the particles to allow infiltration of the water-immiscible liquid constituent into the particles during composition manufacture, and then later egress of the water-immiscible liquid constituent carrying the one or more carboxamide arthropodicides external to the particles into a leaf cuticle or other plant part without needing to disrupt the solid carrier. The solid carrier is primarily intended to provide support, and the material of the solid carrier itself generally does not comprise a water-immiscible liquid constituent, a carboxamide arthropodicide or a surfactant.

If the water-immiscible liquid constituent was mixed with a volatile solvent to facilitate absorption into the solid carrier, a residue of the volatile solvent can remain infiltrated in the carrier after evaporation of the volatile solvent. Typically the amount of residual volatile solvent is not more than about 20%, and more typically not more than about 10% of the water-immiscible liquid constituent. Usually the water-immiscible liquid constituent is absorbed rapidly enough into the solid carrier without dilution with a volatile solvent, and thus the infiltrated material consists essentially of the water-immiscible liquid constituent. In the present composition the water-immiscible liquid constituent is typically primarily (i.e., at least about 80%, more typically at least about 90%, most typically at least about 95%) disposed within the particles of the solid carrier rather than being on the surface of the particles or between the particles.

In the present composition, the one or more carboxamide arthropodicides of component (a) are primarily (i.e. at least about 90%, more typically at least about 95% and most typically at least about 98 or 99%) disposed on the surface of the particles or between the particles of the solid carrier of component (b) rather than being infiltrated inside the particles. Besides the one or more carboxamide arthropodicides, component (c) (i.e. the surfactant component having dispersing and wetting properties) is also primarily disposed on the surface of the particles and between the particles of the solid carrier rather than being infiltrated inside the particles. The surfactant component having dispersing and wetting properties helps disperse the infiltrated particles in an aqueous medium (e.g., in a mixture for spraying on plant foliage). As described herein, other formulating ingredients can also be present on the surface of the particles or between the particles. Water is typically present in application media (e.g., spray mixtures) and the environment. Therefore while other formulating ingredients surrounding the particles have a variety of useful functions and may have correspondingly diverse properties, they typically are selected so that the material on the surface of the particles and between the particles (all of which may be considered to be coating the particles) dissolves or disintegrates in water or at least is weakened or made porous by water, so that transfer of the water-immiscible liquid constituent from the particulate component along with the one or more carboxamide arthropodicides to a leaf cuticle or other plant part is not impeded. As the water-immiscible liquid constituent in the particles can promote transfer of the carboxamide arthropodicides to plant parts, the material surrounding the particles desirably should not retard this transfer.

The composition of the present invention can be applied directly (e.g., as a dust) to the arthropod pest to be controlled (e.g., suppressed or killed) or its environment, such as plant foliage, but usually the composition is first diluted to form a dispersion in water and then sprayed on the arthropod pest or its environment. For control of phytophagous piercing-sucking arthropod pests, spraying the foliage of the plant to be protected with present composition dispersed in water facilitates absorption of the carboxamide arthropodicide active ingredient through the cuticle of the foliage. Addition of the present composition to water typically forms a suspension or suspoemulsion, i.e. a suspension of particles of the solid carrier infiltrated with the water-immiscible liquid constituent and also particles of other insoluble substances such as carboxamide arthropodicides and clays, or (particularly when the solid carrier is water soluble) a suspoemulsion comprising not only the suspension of solid particles but also droplets comprising the water-immiscible liquid carrier.

Without further elaboration, it is believed that one skilled in the art using the preceding description can utilize the present invention to its fullest extent. The following Examples are, therefore, to be construed as merely illustrative, and not limiting of the disclosure in any way.

### FORMULATION EXAMPLES

Examples 1-10 describe preparation of compositions of the present invention. Comparative Examples 1-2 describe preparation of compositions made for comparative purposes. The identities of proprietary ingredients used in these compositions are described in Table 1. The IKA M20 mill referred to in the preparation descriptions was a Model M20 S3 Universal Mill (Universalmuehle) manufactured by IKA Labortechnik, Stauffen, Germany. This mill comprises a rapidly revolving blade cutter in a grinding chamber.

TABLE 1
Identity of Ingredients used in Examples

| Name | Identity |
|---|---|
| Compound 1 | 3-Bromo-1-(3-chloro-2-pyridinyl)- |
| | N-[4-cyano-2-methyl-6-[(methyl- |
| | amino)carbonyl]phenyl]-1H-pyrazole- |
| | 5-carboxamide |
| AGNIQUE ME 18SDU | Methylated soybean oil |
| (Cognis Corp.) | |
| MICROCEL E (Johns-Manville) | Porous calcium silicate powder |
| MARASPERSE N22 (Uniqema) | Calcium lignosulfonate |
| MORWET D425 (Witco) | Sulfonate of naphthalene formaldehyde |
| | condensate, sodium salt |
| Barden Clay | Kaolin clay |
| MORWET EFW (Witco) | Sodium alkylnaphthalenesulfonate |
| RHODACAL BX78 (Rhodia) | Sodium dibutylnaphthalenesulfonate |
| REAX 88B (MeadWestvaco) | Sodium lignosulfonate (highly |
| | sulfonated kraft lignan polymer) |
| CAB-O-SIL M5 (Cabot Corp.) | Fumed silica |

The sample of Compound 1 used in the present Examples and Comparative Examples was prepared as described in Reference Example 1. Amounts listed for Compound 1 refer the amount of technical grade (“tech. grade”) material. The assay of Compound 1 in the technical material varied slightly due to the ability of the material to adsorb varying amounts of water. HPLC analysis of the particular sample used to prepare Comparative Examples 1 and 2 indicated the technical grade material contained 93.4% Compound 1 by weight.

### Reference Example 1

### Preparation of 3-bromo-1-(3-chloro-2-pyridinyl)-N-[4-cyano-2-methyl-6-[(methylamino)-carbonyl]phenyl]-1H-pyrazole-5-carboxamide (Compound 1)

To a mixture of 3-bromo-1-(3-chloro-2-pyridinyl)-1H-pyrazole-5-carboxylic acid (20.6 kg) and 2-amino-5-cyano-N,3-dimethylbenzamide (14.1 kg) in acetonitrile (114 kg) was added 3-picoline (22.2 kg). The mixture was cooled to −10 to −14° C., and then methanesulfonyl chloride (10.6 kg) was slowly added so that the temperature did not exceed 5° C. After reaction completion as ascertained by HPLC and NMR analyses, the mixture was worked up by successively adding water (72.6 kg) and concentrated hydrochloric acid (7.94 kg) at such a rate that the temperature did not exceed 5° C. After being maintained at a temperature not exceeding 5° C. for about 30 minutes, the reaction mixture was filtered to collect the solid product, which was successively washed with acetonitrile-water (2:1, 2×12.3 kg) and acetonitrile (2×10.4 kg). The solid was then dried at about 50° C. under reduced pressure and a flow of nitrogen gas to give the title product as a white crystalline solid, which was directly used in the present formulation Examples and Comparative Examples. With a moderate rate of heating (heating to about 150° C. over 5 minutes and then decreasing rate of heating from about 4-5° C./minute to about 3° C./minute to reach 210° C. over about 15 minutes more) to facilitate volatilization of loosely entrained solvents from the solid product, melting occurred in the range between 204 and 210° C.

### Examples 1-11

### Wettable Powder Formulations

Table 2 lists weight percentage amounts of ingredients used to prepare compositions according to the present invention. The compositions of Examples 1-11 were prepared on a 10 g scale, and therefore the amounts of ingredients used were 10 g multiplied by the listed percentages. According to the general procedure followed, AGNIQUE ME 18 SDU was added to MICROCEL E powder in a beaker, and the ingredients were mixed by stirring gently with a spatula until the powder became flowable again and had a dry appearance. The MICROCEL E powder infiltrated with AGNIQUE ME 18 was then transferred to an IKA M20 mill, and Compound 1, MARASPERSE N22, MORWET D425, Barden Clay, sucrose, lactose (as its monohydrate) and optionally MORWET EFW were added. The mixture was milled for 15 seconds in the IKA M20 mill, and then milling was stopped. The milling process was repeated twice more (i.e. total of three milling cycles lasting 15 seconds each). The finished product was then collected.

TABLE 2
Percentage Amounts of Ingredients Used to Prepare the Compositions of Examples 1-11

| | Example | | | | | | | | | | |
|---|---|---|---|---|---|---|---|---|---|---|---|
| | 1 | 2 | 3 | 4 | 5 | 6 | 7 | 8 | 9 | 10 | 11 |
| | % | % | % | % | % | % | % | % | % | % | % |
| AGNIQUE ME 18SDU | 36.6 | 9.6 | 2.9 | 36.2 | 15.4 | 20.5 | 36.0 | 36.5 | 36.5 | 28.7 | 21.8 |
| MICROCEL E | 18.3 | 4.8 | 1.5 | 18.8 | 23.1 | 20.5 | 18.9 | 18.5 | 18.5 | 26.3 | 33.2 |
| Compound 1, tech. grade | 20.0 | 20.0 | 20.0 | 9.0 | 20.0 | 20.0 | 20.0 | 5.0 | 9.0 | 5.0 | 5.0 |
| MARASPERSE N22 | 3.0 | 3.0 | 3.0 | 3.0 | 3.0 | 3.0 | 3.0 | 3.0 | 3.0 | 3.0 | 3.0 |
| MORWET D425 | 7.0 | 7.0 | 7.0 | 7.0 | 7.0 | 7.0 | 7.0 | 7.0 | 7.0 | 7.0 | 7.0 |
| Barden Clay | 2.0 | 7.0 | 7.0 | 7.0 | 7.0 | 7.0 | 2.0 | 7.0 | 7.0 | 7.0 | 7.0 |
| Sucrose | 1.0 | 1.0 | 1.0 | 1.0 | 1.0 | 1.0 | 1.0 | 1.0 | 1.0 | 1.0 | 1.0 |
| Lactose monohydrate | 12.1 | 47.1 | 57.1 | 17.5 | 23.0 | 20.5 | 12.1 | 21.5 | 17.5 | 21.5 | 21.5 |
| MORWET EFW | 0.0 | 0.5 | 0.5 | 0.5 | 0.5 | 0.5 | 0.0 | 0.5 | 0.5 | 0.5 | 0.5 |

### Example 12

### Wettable Powder Formulation

MICROCEL E (50.00 g) was transferred into a 600 mL glass beaker, and then AGNIQUE ME 18SDU methyl soyate (32.7 g) was added dropwise. The mixture was gently stirred with an overhead mixer until the powder became flowable again and appeared dry. A second sample was similarly prepared on the same scale, and the two samples were well mixed to provide 163.96 g of MICROCEL E infiltrated with methyl soyate. To the MICROCEL E infiltrated with methyl soyate was added technical grade Compound 1, MARASPERSE N22, sucrose, lactose monohydrate, MORWET EFW and Barden clay in amounts specified for Example 11 in Table 2 to provide about 300 g of mixture. The ingredients in the mixture were mixed, and then the mixture was milled twice with a hammer mill (made by Retsch Inc., Newtown, Pa., USA) having a 0.75-mm round hole screen and 6 grinding hammers and operated at 8000 rpm to provide 294.64 g of wettable powder product.

### Example 13

### Wettable Powder Formulation

MICROCEL E (56.82 g) was transferred into a 600 mL glass beaker, and then AGNIQUE ME 18SDU methyl soyate (107.9 g) was added dropwise. The mixture was gently stirred with an overhead mixer until the powder became flowable again and appeared dry. 164.01 g of MICROCEL E infiltrated with methyl soyate was obtained. To the MICROCEL E infiltrated with methyl soyate was added technical grade Compound 1, MARASPERSE N22, sucrose, lactose monohydrate, MORWET EFW and Barden clay in amounts specified for Example 4 in Table 2 to provide about 300 g of mixture. The ingredients in the mixture were mixed, and then the mixture was milled twice with a hammer mill (made by Retsch Inc., Newtown, Pa., USA) having a 0.75-mm round hole screen and 6 grinding hammers and operated at 8000 rpm to provide wettable powder product.

### Comparative Examples 1-2

For comparison, two wettable granule formulations not comprising particles of a solid carrier infiltrated with a water-immiscible liquid constituent were prepared. The ingredients were weighed into a plastic bag according to the proportions specified in Table 3 to prepare 700 g of premix. The ingredients were manually blended by inverting the closed bag several times. Then the entire contents of the bag was milled using a hammer mill with 60 mesh screen. The milled premix was transferred to a paddle kneader, and sufficient water was added to bring the moisture content to 12%. The moistened premix was kneaded in the paddle kneader for 4 minutes and then was transferred to a volumetric screw feeder. The screw feeder moved the premix at a rate of about 450 g/min to a dome extruder. Extruded granules were collected and dried using a fluid bed dryer. Granules obtained by this procedure with the ingredients listed in Table 3 extruded easily and dispersed rapidly in water.

TABLE 3
Percentage Amounts of Ingredients Used to Prepare
the Compositions of Comparative Examples 1-2

Comparative Example

| | 1 | 2 |
|---|---|---|
| | % | % |
| Compound 1, tech. grade | 37.0 | 53.8 |
| RHODACAL BX78 | 0.5 | 0.5 |
| MARASPERSE N22 | 3.0 | 3.0 |
| REAX 88B | 6.0 | 6.0 |
| CAB-O-SIL M5 | 0.5 | 0.5 |
| Barden Clay | 2.0 | 2.0 |
| Sucrose | 1.0 | 1.0 |
| Lactose monohydrate | 50.0 | 33.2 |

### Biological Examples of the Invention

### Test A

Cotton plants grown in Redi-earth media (one plant per pot) were used for testing. Test plants with two true leaves were introduced into cages where adults of silverleaf whitefly (Bemisia argentifolii) were allowed to lay eggs for approximately 24 h. Only plants showing egg lay were used for testing of formulated compositions. Prior to application of the compositions, plants were checked again for egg hatch and crawler (newly hatched whitefly immature) settlement. One leaf per plant was considered as one replication; four replications were used per treatment.

All formulated compositions were mixed in water using four different concentrations of each composition. Plants were sprayed using a TeeJet flat fan spray nozzle positioned 19 cm above the tallest plant. Spray flow provided an application rate equivalent to 468 L/ha. After spraying, plants were allowed to dry in a ventilated enclosure and then moved to a growth chamber operated with 16/8 h daytime/night photoperiod and 28/24° C. daytime/night temperatures and 50% relative humidity.

Evaluations were made 6 days after plants were sprayed. All leaves were removed from each test plant, and the dead and live nymphs present on the underside of each leaf were counted. The data was analyzed by Logit/Probit dose response/mortality regression, and lethal concentrations LC₅₀ and LC₉₀ were calculated in units of g a.i./ha, assuming the entire weight of technical grade Compound 1 to be Compound 1. As the technical grade material was actually less than 100% (e.g., 93%) Compound 1, the actual whitefly control efficacy was actually slightly greater than indicated by the uncorrected calculated LC₅₀ and LC₉₀ values. Each Table (Tables A1, A2, A3 and A4) corresponds to a set of one or more concurrent tests. LC₅₀ and LC₉₀ values are presented rounded to two significant figures, but the compositions of Comparative Examples 1 and 2 exhibited so little activity that only lower bounds for LC₅₀ and LC₉₀ could be meaningfully determined.

TABLE A1
Lethal concentrations of Compound 1 formulated in Comparative
Examples in controlling silverleaf whitefly on cotton (*)

| Composition | LC₅₀ | LC₉₀ |
|---|---|---|
| Comparative Example 1 | >6000 | >190000 |
| Comparative Example 2 | >9000 | >220000 |

(*) LC values are in g a.i./ha. Only lower bounds could be determined, as the comparative formulations showed little activity in this test.

TABLE A2
Lethal concentration of Compound 1 formulated in Examples
1-7 in controlling silverleaf whitefly on cotton (*)

| Composition | LC₅₀ | LC₉₀ |
|---|---|---|
| Example 1 | 1300 | 7900 |
| Example 2 | 1900 | 16000 |
| Example 3 | 1400 | 18000 |
| Example 4 | 110 | 310 |
| Example 5 | 790 | 6000 |
| Example 6 | 300 | 1200 |
| Example 7 | 760 | 3600 |

(*) LC values are in g a.i./ha.

TABLE A3
Lethal concentration of Compound 1 formulated in Example
4 in controlling silverleaf whitefly on cotton (*)

| Composition | LC₅₀ | LC₉₀ |
|---|---|---|
| Example 4 | 170 | 480 |

(*) LC values are in g a.i./ha.

TABLE A4
Lethal concentration of Compound 1 formulated in Examples
8-9 in controlling silverleaf whitefly on cotton (*)

| Composition | LC₅₀ | LC₉₀ |
|---|---|---|
| Example 8 | 200 | 430 |
| Example 9 | 190 | 420 |

(*) LC values are in g a.i./ha.

As can be seen from the results of Table A1, the compositions of Comparative Examples 1 and 2 exhibited little activity controlling silverleaf whitefly in this test. In contrast, all of the compositions of the present invention showed significant activity. Compositions of Example 4 (Tables A2 and A3), Example 6 (Table A2) and Examples 8 and 9 (Table A4) were particularly effective. Activity was observed to increase as the amount of water-immiscible liquid (e.g., methyl soyate) was increased relative to the amount of Compound 1. Accordingly, the composition of Example 4 showed the greatest activity, with only 310 g a.i./ha in one test (Table A2) and 480 g a.i./ha in another test (Table A3) providing 90% kill of whitefly.

What is claimed is:

1. A solid arthropodicide composition comprising by weight
(a) from 0.1 to 50% of one or more carboxamide arthropodicides;
(b) from 0.5 to 95% of a particulate component comprising particles of a solid carrier infiltrated with a water-immiscible liquid constituent;
(c) from 0.1 to 50% of a surfactant component having dispersing and wetting properties; and
(d) from 0 to 99.3% of one or more additional formulating ingredients.

2. The composition of claim 1 wherein the one or more carboxamide arthropodicides comprise a carboxamide arthropodicide comprising at least two vicinal carboxamide moieties bonded to carbon atoms.

3. The composition of claim 2 wherein the one or more carboxamide arthropodicides are selected from anthranilamides of Formula 1, N-oxides, and salts thereof, 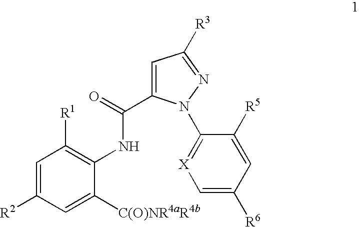
wherein
X is N, CF, CCl, CBr or CI;
R¹ is CH₃, Cl, Br or F;
R² is H, F, Cl, Br or —CN;
R³ is F, Cl, Br, C₁-C₄ haloalkyl or C₁-C₄ haloalkoxy;
R^{4a} is H, C₁-C₄ alkyl, cyclopropylmethyl or 1-cyclopropylethyl;
R^{4b} is H or CH₃;
R⁵ is H, F, Cl or Br; and
R⁶ is H, F, Cl or Br.

4. The composition of claim 3 wherein the one or more carboxamide arthropodicides comprise 3-bromo-1-(3-chloro-2-pyridinyl)-N-[4-cyano-2-methyl-6-[(methylamino)carbonyl]phenyl]-1H-pyrazole-5-carboxamide.

5. The composition of claim 3 wherein the one or more carboxamide arthropodicides comprise 3-bromo-N-[4-chloro-2-methyl-6-[(methylamino)carbonyl]-phenyl]-1-(3-chloro-2-pyridinyl)-1H-pyrazole-5-carboxamide.

6. The composition of claim 2 wherein the one or more carboxamide arthropodicides are selected from phthalic diamides of Formula 2 and salts thereof, 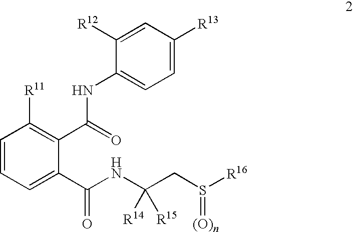
wherein
R¹¹ is CH₃, Cl, Br or I;
R¹² is CH₃ or Cl;
R¹³ is C₁-C₃ fluoroalkyl;
R¹⁴ is H or CH₃;
R¹⁵ is H or CH₃;
R¹⁶ is C₁-C₂ alkyl; and
n is 0, 1 or 2.

7. The composition of claim 6 wherein the one or more carboxamide arthropodicides comprise N²-[1,1-dimethyl-2-(methylsulfonyl)ethyl]-3-iodo-N¹-[2-methyl-4-[1,2,2,2-tetrafluoro-1-(trifluoromethyl)ethyl]phenyl]-1,2-benzenedicarboxamide.

8. The composition of claim 1 wherein the solid carrier comprises at least one silica or silicate.

9. The composition of claim 8 wherein the solid carrier comprises calcium silicate.

10. The composition of claim 1 wherein the water-immiscible liquid constituent comprises a at least one substance selected from fatty acid esters of C₁-C₄ alkanols, seed and fruit oils and mineral oils

11. The composition of claim 10 wherein the water-immiscible liquid constituent comprises a methylated seed oil.

12. The composition of claim 1 wherein the surfactant component comprises one or more surfactants selected from the group consisting of alkylnaphthalenesulfonates, salts of naphthalene formaldehyde condensate sulfonates, and lignosulfonates.

13. The composition of claim 1 wherein the one or more additional formulating ingredients comprise one or more clays in an amount ranging from 1 to 15% of the composition by weight.

14. The composition of claim 1 wherein the one or more additional formulating ingredients comprise one or more saccharides in an amount ranging from 1 to 85% of the composition by weight.
